(19) United States
(12) Patent Application Publication
(10) Pub. No.: US 2009/0034145 A1
(43) Pub. Date: Feb. 5, 2009

(54) DC Type Ionizer

(75) Inventors: Tetsuya Tokunaga, Tokyo (JP); Yasunori Terasaki, Tokyo (JP); Humitaka Irie, Tokyo (JP)

Correspondence Address: BIRCH STEWART KOLASCH & BIRCH, PO BOX 747, FALLS CHURCH, VA, 22040-0747, US

(73) Assignee: HUGLE ELECTRONICS INC., Tokyo (JP)

(21) Appl. No.: 11/886,671

(22) PCT Filed: May 24, 2005
(86) PCT No.: PCT/JP2005/009828

§ 371 Date: Sep. 19, 2007

(51) Int. Cl. H01T 23/00

(52) U.S. Cl. 361/231

(57) ABSTRACT

The present invention relates to a DC type ionizer comprising a positive electrode 13P and a negative electrode 13N, an alternating current power supply 10, a rectifying and smoothing circuit 11, and high voltage generation circuits 12P and 12N that apply a high direct current constant voltage of positive polarity to the positive electrode 13P and apply a high direct current constant voltage of negative polarity to the negative electrode 13N, respectively, and a fan 14 that sends positive and negative ions generated by corona discharge around each of the electrodes 13P and 13N, in the direction of a target of static electricity removal. Each of the electrodes 13P and 13N is arranged behind the fan 14 and ion number sensors 15P and 15N are arranged at positions ahead of the fan 14 and corresponding to the electrodes 13P and 13N, and the positive ions and the negative ions are caused to arrive intermittently at the corresponding ion number sensors 15P and 15N by the rotation of the fan 14 and ion currents corresponding to the numbers of positive and negative ions are detected, respectively. Due to this, a function of monitoring the number of generated ions is realized with a simple configuration and a DC type ionizer that facilitates ion balance control and generation of an electrode cleaning alarm is realized.

### TECHNICAL FIELD

The present invention relates to a DC type ionizer that sends generated ions in the direction of a target of static electricity removal using a fan and, more particularly, to a DC type ionizer in which a detector that detects the number of generated ions is improved.

### BACKGROUND ART

A DC type ionizer provided with a fan has been known as one that removes static electricity of a target by applying a high positive voltage and a high negative voltage to positive and negative electrodes (emitters), respectively, and sending using a fan positive ions and negative ions generated by corona discharge around each of the electrodes in the direction of the target of static electricity removal.

The DC type ionizer of this type has a function of monitoring the number of ions generated from positive and negative electrodes using an ion number sensor in order to confirm performance of static electricity removal or keep a balance between positive and negative ions, or notify of when the cleaning time will come based on stains of each of the electrodes.

Such a DC type ionizer having the function of monitoring the number of generated ions is described in, for example, Patent Documents 1 to 4.
(1) Patent Document 1: Japanese Patent Application Laid-open No. H02-267880 (line 1 in the right upper column on page 2 to line 12 in the right upper column on page 3, FIGS. 1 and 2, etc.)
(2) Patent Document 2: Japanese Patent Application Laid-open No. H11-135293 ([0031] to [0042], FIGS. 1 and 2, etc.)
(3) Patent Document 3: Japanese Patent Application Laid-open No. H03-266398 (line 1 in the left lower column on page 2 to line 4 in the left upper column on page 5, FIG. 1, etc.)
(4) Patent Document 4: Japanese Patent No. 3572541 ([0013] to [0038], FIG. 1, etc.)

For example, when the number of ions is detected by placing an ion number sensor close to the positive electrode or the negative electrode of a DC type ionizer, if a high voltage applied to each of the electrodes is a direct current constant voltage (positive direct current high voltage or negative direct current high voltage), the ion number sensor is just positively or negatively charged due to the positive ions or negative ions generated from each of the electrodes. Therefore, no change in voltage is caused and thus no induced current flows through the ion number sensor. As a result, the ion current and therefore the number of ions cannot be detected.

Because of this, in each of the above-mentioned conventional technologies, an induced current flowing through the ion number sensor, which is caused by applying a positive high frequency voltage or a negative high frequency voltage to the positive and negative electrodes, is detected as the number of ions.

However, with such a configuration, there arises a problem in that the configuration of the high frequency power supply circuit becomes complex, the DC type ionizer is upsized, and its cost is raised.

The present invention has been achieved to solve the above problems, and an object thereof is to provide a DC type ionizer that realizes a function of monitoring the number of generated ions with a remarkably simple configuration and which makes easier ion balance control and generation of an electrode cleaning alarm.

### DISCLOSURE OF THE INVENTION

To solve the above problems, the invention according to claim 1 provides a DC type ionizer, comprising: positive and negative electrodes; a high voltage generator that applies a high direct current constant voltage of positive polarity to the positive electrode and applies a high direct current constant voltage of negative polarity to the negative electrode; and a fan that sends positive ions and negative ions generated by corona discharge around the positive electrode and the negative electrode in the direction of a target of static electricity removal, wherein the positive electrode and the negative electrode are arranged behind the fan and an ion number sensor for positive ions and an ion number sensor for negative ions are arranged at positions ahead of the fan and corresponding to the positive electrode and the negative electrode, respectively, and the positive ions and the negative ions are caused to arrive intermittently at the corresponding ion number sensors by rotation of the fan and ion currents corresponding to the number of positive ions and the number of negative ions are detected by the ion number sensors, respectively.

Furthermore, the invention according to claim 2 provides the DC type ionizer of claim 1, further comprising a unit that displays the numbers of positive and negative ions by converting the positive and negative ion currents detected by the corresponding ion number sensors into voltages.

Further, the invention according to claim 3 provides the DC type ionizer of claim 2, wherein the unit that displays the numbers of positive and negative ions is a unit that displays the number of positive ions and the number of negative ions in a bar graph by light emission.

Further, the invention according to claim 4 provides the DC type ionizer of any one of claims 1 to 3, wherein the numbers of positive and negative ions are balanced by adjusting the voltage to be applied to the positive electrode or the negative electrode by the high voltage generator in accordance with the positive and negative ion currents detected by the corresponding ion number sensors.

### BRIEF DESCRIPTION OF THE DRAWINGS

FIG. 1 is a schematic configuration diagram of an embodiment of the present invention.

FIGS. 2 are waveform diagrams for explaining operations according to the embodiment of the present invention.

### BEST MODES FOR CARRYING OUT THE INVENTION

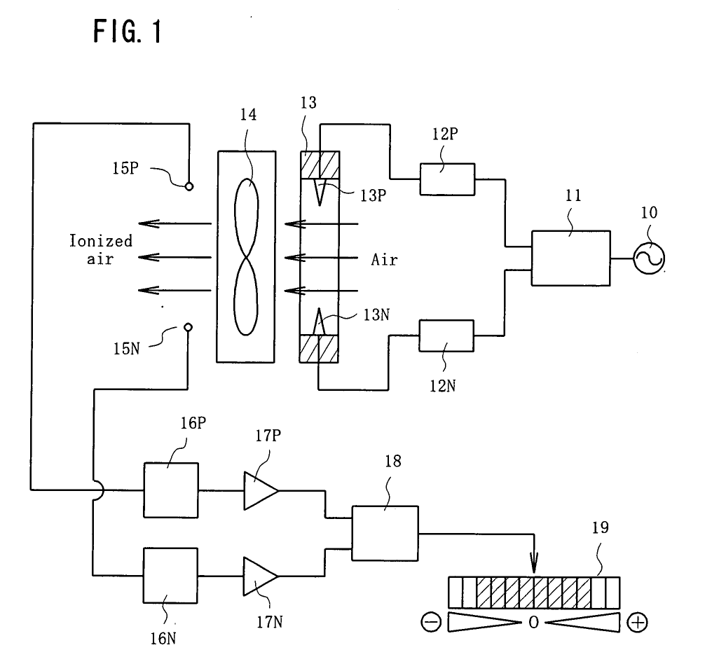

Embodiments of the present invention will be explained below with reference to the drawings. FIG. 1 is a schematic configuration diagram of an embodiment of the present invention.

In FIG. 1, reference numeral 10 denotes an alternating current power supply and 11 denotes a rectifying and smoothing circuit that generates a direct current voltage by rectifying and smoothing an alternating current power supply voltage. A direct current power supply, such as a storage battery, can be used instead of the alternating current power supply 10 and the rectifying and smoothing circuit 11.

Reference numerals 12P and 12N denote high voltage generation circuits that raise output voltages of the rectifying and smoothing circuit 11 to positive and negative high direct current constant voltages, respectively. The positive and negative high voltages output from the high voltage generation circuits 12P and 12N are applied to a positive electrode 13P and a negative electrode 13N, respectively. The electrodes 13P and 13N are arranged so that their centers face an inner circumferential surface of a ring-shaped electrode holder. The electrodes 13P and 13N are each provided 180 degrees apart from each other, however, two of the electrodes 13P and 13N can be arranged alternately at every 90 degrees.

In the configuration mentioned above, the alternating current power supply 10, the rectifying and smoothing circuit 11, and the high voltage generation circuits 12P and 12N constitute a high voltage generator described in claims.

Ahead of an electrode holder 13, there is provided a fan 14 that sends positive and negative ions generated around the electrodes 13P and 13N in the direction of a target of static electricity removal (not shown).

Ahead of the fan 14, there are provided a positive ion number sensor 15P and a negative ion number sensor 15N corresponding to each of the electrodes 13P and 13N.

The outputs of the ion number sensors 15P and 15N are input to converters 16P and 16N and their outputs are input to a display control circuit 18 via amplifiers 17P and 17N, respectively.

The output of the display control circuit 18 is input to an ion number display device 19 that displays the number of ions in the form of a bar graph, and thereby, it is possible to visually display the numbers of positive and negative ions by causing display elements to emit light in accordance with the numbers of positive and negative ions.

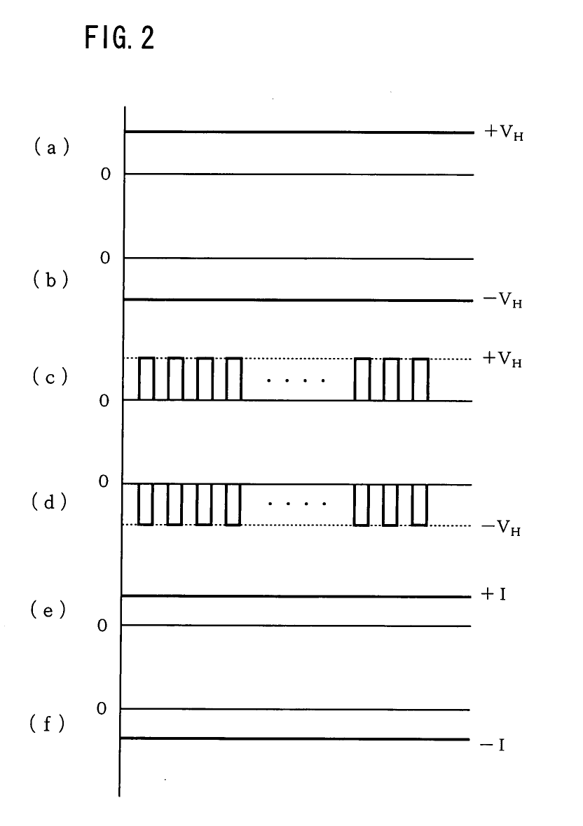

Operations of the present embodiment are explained next with reference to FIG. 2.

FIGS. 2(a) and 2(b) show positive and negative direct current constant voltages +V_{H} and +V_{L} to be applied to the positive and negative electrodes 13P and 13N by the high voltage generation circuits 12P and 12n, respectively. Due to the application of the voltages to the respective voltages 13P and 13N, positive and negative ions are generated by corona discharge around the respective electrodes 13P and 13N, and the positive and negative ions move forward being carried by an air current caused by rotation of the fan 14.

At this time, the ionized air is chopped by the rotation of the fan 14, and therefore, the positive and negative ions arrive intermittently at the positive ion number sensor 15P and the negative ion number sensor 15N, respectively. Due to this, pulse-shaped voltages synchronized with the rotation frequency of the fan 14 are induced at the ion number sensors 15P and 15N, as shown in FIGS. 2(c) and 2(d).

Because of this, induced currents in accordance with the above-mentioned voltages flow through the respective ion number sensors 15P and 15N, and the average values +I_{H} and −I_{L} are shown in FIGS. 2(e) and 2(f).

The ion currents are converted into positive and negative voltages by the converters 16P and 16N, and amplified by the amplifiers 17P and 17N, respectively, and input to the display control circuit 18.

The display control circuit 18 generates a display control signal in order to cause a predetermined number of display elements in the ion number display device 19 to emit light in accordance with each of the positive and negative voltage levels. The display control signal is input to the ion number display device 19 to produce a display by light emission.

Due to this, it is possible to display the numbers of positive and negative ions detected by the ion number sensors 15P and 15N, by the ion number display device 19 and it is possible to visually recognize which ion is larger or smaller in number and their ion balance.

It is also possible to balance the numbers of generated positive and negative ions by feeding back the output signals of the amplifiers 17P and 17N to the high voltage generation circuit 12P or 12N to adjust the voltage applied to each of the electrodes 13P and 13N.

According to the present invention, it is possible to induce ion currents in accordance with the numbers of positive and negative ions and display the numbers of generated positive and negative ions and the ion balance by chopping positive and negative ions generated around positive and negative electrodes by the rotation of a fan, to be caused to arrive at positive and negative ion number sensors, without the need to use a high frequency power supply circuit.

Due to this, it is possible to downsize a DC type ionizer and reduce its cost by simplifying the configuration of the power supply circuit.

1. A DC type ionizer, comprising:
positive and negative electrodes;
a high voltage generator that applies a high direct current constant voltage of positive polarity to the positive electrode and applies a high direct current constant voltage of negative polarity to the negative electrode; and
a fan that sends positive ions and negative ions generated by corona discharge around the positive electrode and the negative electrode in the direction of a target of static electricity removal, wherein
the positive electrode and the negative electrode are arranged behind the fan and an ion number sensor for positive ions and an ion number sensor for negative ions are arranged at positions ahead of the fan and corresponding to the positive electrode and the negative electrode, respectively, and
the positive ions and the negative ions are caused to arrive intermittently at the corresponding ion number sensors by rotation of the fan and ion currents corresponding to the number of positive ions and the number of negative ions are detected by the ion number sensors, respectively.

2. The DC type ionizer according to claim 1, further comprising a unit that displays the numbers of positive and negative ions by converting the positive and negative ion currents detected by the corresponding ion number sensors into voltages.

3. The DC type ionizer according to claim 2, wherein the unit that displays the numbers of positive and negative ions is a unit that displays the number of positive ions and the number of negative ions in a bar graph by light emission.

4. The DC type ionizer according to any one of claims 1 to 3, wherein the numbers of positive and negative ions are balanced by adjusting the voltage to be applied to the positive electrode or the negative electrode by the high voltage generator in accordance with the positive and negative ion currents detected by the corresponding ion number sensors.
